(19) United States
(12) Patent Application Publication
(10) Pub. No.: US 2025/0208972 A1
(43) Pub. Date: Jun. 26, 2025

(54) EDGE DEVICE DEVELOPMENT SUPPORT APPARATUS AND METHOD

(71) Applicant: ELECTRONICS AND TELECOMMUNICATIONS RESEARCH INSTITUTE, Daejeon (KR)

(72) Inventor: Tae Chul HONG, Daejeon (KR)

(73) Assignee: ELECTRONICS AND TELECOMMUNICATIONS RESEARCH INSTITUTE, Daejeon (KR)

(21) Appl. No.: 18/393,518

(22) Filed: Dec. 21, 2023

(30) Foreign Application Priority Data
Dec. 20, 2022 (KR) 10-2022-0179657

(51) Int. Cl. G06F 11/34

(52) U.S. Cl. CPC G06F 11/3447; G06F 11/3409

(57) ABSTRACT

The present invention relates to an edge device development support apparatus and method, and the edge device development support apparatus includes a user interface unit configured to provide a user interface, and a processor configured to execute an artificial intelligence model on hardware to be used in an edge device, estimate the performance of the hardware, calculate the cost of the hardware that is incurred by utilizing the hardware, then select hardware according to the performance and the cost, and output the selected hardware through the user interface.

### CROSS-REFERENCE TO RELATED APPLICATION

This application claims priority to and the benefit of Korean Patent Application No. 10-2022-0179657, filed on Dec. 20, 2022, the disclosure of which is incorporated herein by reference in its entirety.

### BACKGROUND

### 1. Field of the Invention

The present invention relates to an edge device development support apparatus and method, and more specifically, to an edge device development support apparatus and method that selects artificial intelligence acceleration hardware to be used in edge devices and provides the selected artificial intelligence acceleration hardware to developers.

### 2. Discussion of Related Art

Artificial intelligence, particularly, deep learning, requires many computational resources so that, in order for edge devices to perform artificial intelligence inference calculations without using clouds, low-power and high-efficiency artificial intelligence acceleration hardware is required together with lightening and optimization of artificial intelligence models.

Lightening and optimization of artificial intelligence models are mainly performed by artificial intelligence model experts, but recently, methods are being provided that allow non-experts to develop artificial intelligence models that meet their needs using an automated machine learning (AutoML) platform.

Low-power and high-efficiency artificial intelligence acceleration hardware is being developed by various companies for various applications, and thus it is difficult to determine the performance of an artificial intelligence model in artificial intelligence acceleration hardware during the artificial intelligence model development stage.

### SUMMARY OF THE INVENTION

The present invention is directed to providing an edge device development support apparatus and method that selects hardware on the basis of the performance of an artificial intelligence model in artificial intelligence acceleration hardware to be used in edge devices and the cost of the hardware that is incurred by utilizing the artificial intelligence acceleration hardware, and provides the selected hardware to developers.

According to an aspect of the present disclosure, there is provided an edge device development support apparatus including a user interface unit configured to provide a user interface, and a processor configured to execute an artificial intelligence model on hardware to be used in an edge device, estimate the performance of the hardware, calculate the cost of the hardware that is incurred by utilizing the hardware, then select hardware according to the performance and the cost, and output the selected hardware through the user interface.

The processor may receive the artificial intelligence model through the user interface unit or receive data for the function and training of the artificial intelligence model through the user interface unit, and generate the artificial intelligence model through automated machine learning (AutoML).

The AutoML may search for a structure of an artificial intelligence model that takes a hardware structure of the edge device into consideration and lighten or optimize the artificial intelligence model in consideration of the performance of the edge device.

The processor may determine whether the performance satisfies a preset performance requirement by reflecting an error in the performance estimation.

The processor may estimate the performance by executing the artificial intelligence model on an actual hardware platform, estimate the performance using a hardware structure and artificial intelligence model analysis, estimate the performance using a lookup table for performance estimation that is stored for each piece of hardware, or estimate the performance using a machine learning model developed based on performance data obtained by executing the artificial intelligence model on actual hardware.

The processor may calculate the cost of the hardware whose performance satisfies the preset performance requirement among the hardware.

The processor may calculate the cost of the hardware by reflecting preset cost conditions for each piece of hardware.

The cost conditions may include at least one of price, development difficulty, and hardware development support environment.

The price may be normalized based on prices for released hardware products, and the development difficulty and the hardware development support environment may be defined by grade and normalized.

The processor may select hardware by reflecting a weight on at least one of the performance and the cost.

According to another aspect of the present disclosure, there is provided an edge device development support method including executing, by a processor, an artificial intelligence model on hardware to be used in an edge device and estimating the performance of the hardware, calculating, by the processor, the cost of the hardware that is incurred by utilizing the hardware, and selecting, by the processor, hardware according to the performance and the cost.

In the estimating of the performance of the hardware, the processor may receive the artificial intelligence model through the user interface unit or receive data for the function and training of the artificial intelligence model through the user interface unit, and generate the artificial intelligence model through AutoML.

The AutoML may search for a structure of an artificial intelligence model that takes a hardware structure of the edge device into consideration and lighten or optimize the artificial intelligence model in consideration of the performance of the edge device.

In the estimating of the performance of the hardware, the processor may determine whether the performance satisfies a preset performance requirement by reflecting an error in the performance estimation.

In the estimating of the performance of the hardware, the processor may estimate the performance by executing the artificial intelligence model on an actual hardware platform, estimate the performance using a hardware structure and artificial intelligence model analysis, estimate the performance using a lookup table for performance estimation that is stored for each piece of hardware, or estimate the performance using a machine learning model developed based on performance data obtained by executing the artificial intelligence model on actual hardware.

In the calculating of the cost of the hardware, the processor may calculate the cost of the hardware whose performance satisfies the preset performance requirement among the hardware.

In the calculating of the cost of the hardware, the processor may calculate the cost of the hardware by reflecting preset cost conditions for each piece of hardware.

The cost conditions may include at least one of price, development difficulty, and hardware development support environment.

The price may be normalized based on prices for released hardware products, and the development difficulty and the hardware development support environment may be defined by grade and normalized.

In the selecting of the hardware, the processor may select hardware by reflecting a weight on at least one of the performance and the cost.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of an edge device development support apparatus according to an embodiment of the present invention;

FIG. 2 is a flowchart of an edge device development support method according to an embodiment of the present invention;

FIG. 3 is a diagram illustrating automated machine learning (AutoML) according to an embodiment of the present invention; and

FIG. 4 is a diagram illustrating an example in which hardware is selected based on an estimated performance value according to an embodiment of the present invention.

### DETAILED DESCRIPTION OF EXEMPLARY EMBODIMENTS

Hereinafter, examples of an edge device development support apparatus and method according to embodiments of the present invention will be described. In this process, thicknesses of lines, sizes of components, and the like shown in the accompanying drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

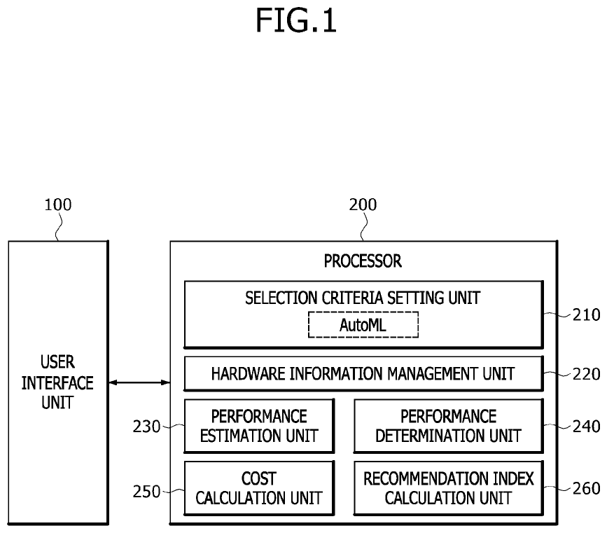

FIG. 1 is a block diagram of an edge device development support apparatus according to an embodiment of the present invention.

Referring to FIG. 1, the edge device development support apparatus according to the embodiment of the present invention includes a user interface unit 100 and a processor 200.

The user interface unit 100 provides a user interface.

The user interface unit 100 receives an artificial intelligence model (machine learning model) to be developed from a user.

Alternatively, the user interface unit 100 may receive data for the function and training of the artificial intelligence model through the user interface.

The user interface unit 100 outputs hardware selected by the processor 200.

When a plurality of pieces of hardware are selected, the user interface unit 100 may output the selected hardware as a descending order list. The method by which the user interface unit 100 outputs hardware is not particularly limited.

The user interface unit 100 receives performance requirements and requirements for cost conditions that are required for an edge device.

The performance requirements are criteria for determining whether hardware satisfies minimum performance requirements (min key performance indicators (KPIs)).

The cost conditions are used for calculating hardware cost.

The performance requirements and the cost conditions will be described below.

The processor 200 may receive an artificial intelligence model from the user interface unit 100 or data for the function and training of the artificial intelligence model through the user interface unit 100.

The processor 200 executes the artificial intelligence model to estimate hardware performance and calculate the cost of the hardware that is incurred by utilizing the hardware.

The processor 200 selects hardware according to hardware performance and cost and outputs the selected hardware through the user interface.

Here, the artificial intelligence model is an artificial intelligence model to be used in the edge device.

The artificial intelligence model may be an artificial intelligence model input from the user interface unit 100 or an artificial intelligence model generated through automated machine learning (AutoML) on the basis of data for the function and training of the artificial intelligence model.

For example, a keyboard, a mouse, a touch pad, a touch screen, an electronic pen, a touch button, etc. may be provided as the user interface. Further, the user interface may include a printer, a display, etc. in order to output data. Here, the display may be implemented as, for example, a thin film transistor-liquid crystal display (TFT-LCD) panel, a light-emitting diode (LED) panel, an organic LED (OLED) panel, an active-matrix OLED (AMOLED) panel, a flexible panel, etc.

The processor 200 may be connected to a memory (not illustrated), and instructions for performing operations, steps, etc. according to embodiments of the present invention, which will be described below, may be stored in the memory. Here, the memory may include magnetic storage media or flash storage media in addition to volatile storage devices that require power to maintain stored information, but the scope of the present invention is not limited thereto.

Further, as will be described below, in the processor 200, components for performing each function may be configured separately at the hardware, software, or logic level. In this case, dedicated hardware for performing each function may be used. To this end, the processor 200 may be implemented as at least one of application specific integrated circuits (ASICs), digital signal processors (DSPs), programmable logic devices (PLDs), field programmable gate arrays (FPGAs), central processing units (CPUs), microcontrollers, and/or microprocessors or may include at least one thereof.

The processor 200 includes a selection criteria setting unit 210, a hardware information management unit 220, a performance estimation unit 230, a performance determination unit 240, a cost calculation unit 250, and a recommendation index calculation unit 260.

The selection criteria setting unit 210 receives requirements for recommending hardware from a user and sets related parameters.

The selection criteria setting unit 210 may receive an artificial intelligence model from the user interface unit 100 or receive data for the function and training of the artificial intelligence model through the user interface unit 100, according to whether AutoML is installed therein.

AutoML automatically generates a machine learning model by providing requirements for artificial intelligence services and data required for development. AutoML allows the user to develop an edge device artificial intelligence service without an artificial intelligence model developer.

When AutoML is not installed, the selection criteria setting unit 210 receives an artificial intelligence model from the user interface unit 100.

When AutoML is installed, the selection criteria setting unit 210 receives data for the function and training of the artificial intelligence model from the user interface unit 100. In this case, AutoML may generate an artificial intelligence model on the basis of the data for the function and training of the artificial intelligence model. The AutoML may search for a structure of an artificial intelligence model that takes a hardware structure of an edge device into consideration, and lighten and optimize the artificial intelligence model in consideration of the performance of the edge device.

The hardware information management unit 220 is configured to store and manage a list of pieces of available hardware, a hardware structure, hardware performance estimation-related information, and cost-related information.

The list of the pieces of available hardware, the hardware structure, the hardware performance estimation-related information, and the cost-related information may be used for hardware performance estimation and cost calculation.

The performance estimation unit 230 estimates the performance of the hardware when the artificial intelligence model is executed in the hardware present in the hardware list, according to a performance estimation method. The performance estimation method will be described below.

The performance determination unit 240 determines whether the performance estimated by the performance estimation unit 230 satisfies minimum performance requirements. The performance determination unit 240 excludes the hardware in the hardware list, whose performance does not satisfy the minimum performance requirements, from a candidate group.

The cost calculation unit 250 calculates the cost of the hardware by reflecting cost conditions for pieces of hardware that satisfy performance requirements.

The recommendation index calculation unit 260 calculates recommendation indexes obtained by reflecting weights on the cost and performance of the pieces of hardware that satisfy the performance requirements, organizes the hardware list by sorting the recommendation indexes in descending order, and outputs the hardware list through the user interface unit 100.

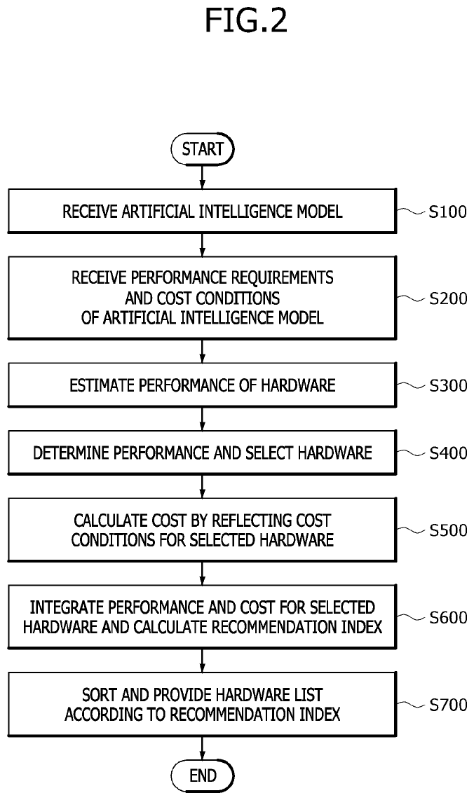

Hereinafter, an edge device development support method according to an embodiment of the present invention will be described with reference to FIGS. 2 to 4.

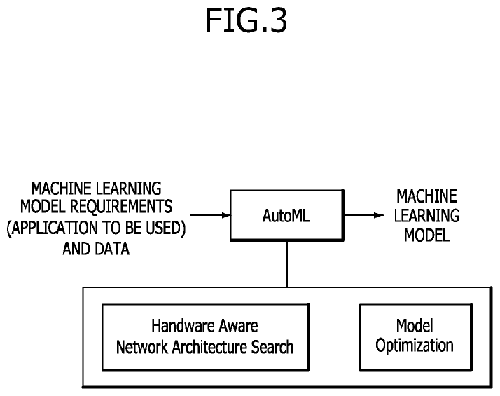

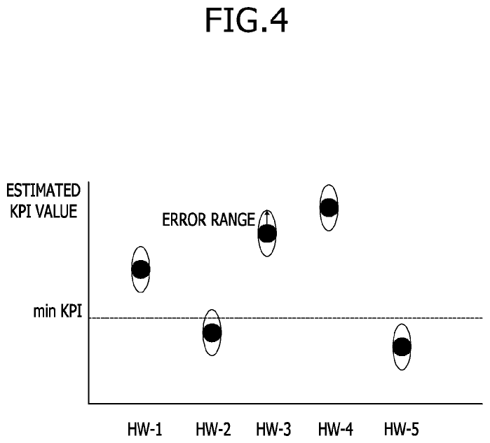

FIG. 2 is a flowchart of an edge device development support method according to an embodiment of the present invention, FIG. 3 is a diagram illustrating AutoML according to an embodiment of the present invention, and FIG. 4 is a diagram illustrating an example in which hardware is selected based on an estimated performance value according to an embodiment of the present invention.

Referring to FIG. 2, the selection criteria setting unit 210 receives an artificial intelligence model from a user interface unit 100 (S100).

When AutoML is installed, the selection criteria setting unit 210 may receive data for the function and training of the artificial intelligence model through the user interface unit 100.

AutoML may generate an artificial intelligence model on the basis of the data for the function and training of the artificial intelligence model. As illustrated in FIG. 3, AutoML may search for a structure of an artificial intelligence model that takes a hardware structure of an edge device into consideration, and lighten and optimize the artificial intelligence model in consideration of the performance of the edge device.

The selection criteria setting unit 210 receives performance requirements and requirements for cost conditions that are required for the edge device from the user interface unit 100 (S200).

The selection criteria setting unit 210 sets related parameters according to the performance requirements and the requirements for the cost conditions that are received from the user interface unit 100.

The parameters are stored in the hardware information management unit 220.

The performance estimation unit 230 estimates hardware performance when the artificial intelligence model is executed on hardware present in a hardware list (S300).

Examples of a performance estimation method may include a method of estimating hardware performance by executing the artificial intelligence model on an actual hardware platform, a method of estimating hardware performance using a hardware structure and artificial intelligence model analysis, a method of estimating hardware performance using a lookup table for performance estimation that is stored for each piece of hardware, or a method of estimating hardware performance using a machine learning model developed based on performance data obtained by executing the artificial intelligence model on actual hardware.

Here, in the method of estimating hardware performance by executing an artificial intelligence model on an actual hardware platform, performance may be accurately measured.

On the other hand, in the method of estimating hardware performance using a hardware structure and artificial intelligence model analysis, the method of estimating hardware performance using a lookup table for performance estimation that is stored for each piece of hardware, or the method of estimating hardware performance using a machine learning model developed based on performance data obtained by executing the artificial intelligence model on actual hardware, results may be identified relatively rapidly, but estimation errors may occur.

Accordingly, the performance determination unit 240 determines whether performance satisfies preset minimum performance requirements by reflecting the errors occurring according to the performance estimation method in which performance is estimated, and selects hardware according to a result of the determination (S400).

That is, the performance determination unit 240 considers an estimation error when determining whether the estimated performance satisfies the minimum performance requirements. When the estimation error occurring according to the performance estimation method is a, the performance determination unit 240 makes a determination in consideration of ±a of an estimated value.

Referring to FIG. 4, the performance determination unit 240 does not exclude cases in which performance satisfies performance requirements, for example, minimum performance requirements, within an error range, like HW-2, and makes a determination in consideration of the performance requirements together with the cost in the next stage.

When there are multiple required KPIs, the performance determination unit 240 selects only hardware that satisfies the minimum performance requirements for all KPIs.

Examples of the KPIs may include inference latency, energy consumption, and memory size, but the type of KPI is not particularly limited.

The cost calculation unit 250 calculates the cost of the hardware whose performance satisfies the preset performance requirements among the hardware (S500).

The cost calculation unit 250 calculates the cost of the hardware through Equation 1 below by reflecting weights on price (Money), development difficulty (Difficulty), and hardware development support environment (Support).

$$Cost = a \cdot M ( money ) + b \cdot D ( difficulty ) + c \cdot S ( Support ) \qquad [ Equation l ]$$

Here, M denotes the price, D denotes the development difficulty, and S denotes the hardware development support environment. a, b, and c denote input cost conditions and are constants.

The price is normalized based on prices for released products, and the difficulty and support level are normalized to values between 0 to 1 for defined grades.

For difficulty, a larger value means lower difficulty, and for support level, a larger value means a higher level of support.

Table 1 below is an example of normalization values reflected when calculating costs. M, D, and S reflect values between 0 to 1.

TABLE 1

| Types of HW | M (money) | D (difficulty) | S (support) |
|---|---|---|---|
| HW-1 | 0.3 | 0.1 | 0.2 |
| HW-2 | 0.5 | 0.7 | 0.7 |
| . . . | . . . | . . . | . . . |

Referring to Table 1, M, D, and S reflect values between 0 to 1.

The recommendation index calculation unit 260 selects hardware by reflecting weights on the performance and cost of the hardware (S700).

That is, the recommendation index calculation unit 260 integrates performance (KPIs) and cost to calculate a recommendation index value as shown in Equation 2 below, and identifies hardware with a maximum recommendation index value.

$${max}_{i} {\sum }_{j} {α}_{j} \cdot {KPI}_{ij} + β \cdot {C}_{i} \qquad [ Equation 2 ]$$

Here, i denotes an index of the hardware, j denotes an index of the KPI, KPI denotes the key performance indicator, and C denotes the cost. α and β denote conditions input by the user and are constants.

When there are multiple KPIs, different weights may be assigned to respective KPI items, or the same weight may be assigned.

Next, the recommendation index calculation unit 260 sorts and provides a hardware list according to the recommendation indexes (S700).

That is, the recommendation index calculation unit 260 may identify only hardware with a maximum value and output the identified hardware through the user interface unit the 100. However, since various considerations can be additionally reflected, recommendation index calculation unit 260 organizes the hardware list by sorting the recommendation indexes in descending order and outputs the hardware list through the user interface unit 100.

The edge device development support apparatus and method according to the present invention can select hardware on the basis of the performance of an artificial intelligence model in artificial intelligence acceleration hardware to be used in edge devices and the cost of the hardware that is incurred by utilizing the artificial intelligence acceleration hardware and provide the selected hardware to developers, thereby supporting the developers to develop edge devices using optimal hardware.

While the present invention has been described with reference to embodiments illustrated in the accompanying drawings, the embodiments should be considered in a descriptive sense only, and it should be understood by those skilled in the art that various modifications and other equivalent embodiments may be made. Therefore, the scope of the present invention should be defined by only the following claims.

What is claimed is:

1. An edge device development support apparatus comprising:
a user interface unit configured to provide a user interface; and
a processor configured to execute an artificial intelligence model on hardware to be used in an edge device, estimate performance of the hardware, calculate a cost of the hardware that is incurred by utilizing the hardware, then select hardware according to the performance and the cost, and output the selected hardware through the user interface.

2. The edge device development support apparatus of claim 1, wherein the processor receives the artificial intelligence model through the user interface unit or receives data for a function and training of the artificial intelligence model through the user interface unit, and generates the artificial intelligence model through automated machine learning (AutoML).

3. The edge device development support apparatus of claim 2, wherein the AutoML searches for a structure of an artificial intelligence model that takes a hardware structure of the edge device into consideration and lightens or optimizes the artificial intelligence model in consideration of performance of the edge device.

4. The edge device development support apparatus of claim 1, wherein the processor determines whether the performance satisfies a preset performance requirement by reflecting an error in the performance estimation.

5. The edge device development support apparatus of claim 1, wherein the processor estimates the performance by executing the artificial intelligence model on an actual hardware platform, estimates the performance using a hardware structure and artificial intelligence model analysis, estimates the performance using a lookup table for performance estimation that is stored for each piece of hardware, or estimates the performance using a machine learning model developed based on performance data obtained by executing the artificial intelligence model on actual hardware.

6. The edge device development support apparatus of claim 1, wherein the processor calculates a cost of the hardware whose performance satisfies the preset performance requirement among the hardware.

7. The edge device development support apparatus of claim 1, wherein the processor calculates the cost of the hardware by reflecting preset cost conditions for each piece of hardware.

8. The edge device development support apparatus of claim 7, wherein the cost conditions include at least one of price, development difficulty, and hardware development support environment.

9. The edge device development support apparatus of claim 8, wherein the price is normalized based on prices for released hardware products, and the development difficulty and the hardware development support environment are defined by grade and normalized.

10. The edge device development support apparatus of claim 1, wherein the processor selects hardware by reflecting a weight on at least one of the performance and the cost.

11. An edge device development support method comprising:
executing, by a processor, an artificial intelligence model on hardware to be used in an edge device and estimating performance of the hardware;
calculating, by the processor, a cost of the hardware that is incurred by utilizing the hardware; and
selecting, by the processor, hardware according to the performance and the cost.

12. The edge device development support method of claim 11, wherein, in the estimating of the performance of the hardware, the processor receives the artificial intelligence model through a user interface unit or receives data for a function and training of the artificial intelligence model through the user interface unit, and generates the artificial intelligence model through automated machine learning (AutoML).

13. The edge device development support method of claim 12, wherein the AutoML searches for a structure of an artificial intelligence model that takes a hardware structure of the edge device into consideration and lightens or optimizes the artificial intelligence model in consideration of performance of the edge device.

14. The edge device development support method of claim 11, wherein, in the estimating of the performance of the hardware, the processor determines whether the performance satisfies a preset performance requirement by reflecting an error in the performance estimation.

15. The edge device development support method of claim 11, wherein, in the estimating of the performance of the hardware, the processor estimates the performance by executing the artificial intelligence model on an actual hardware platform, estimates the performance using a hardware structure and artificial intelligence model analysis, estimates the performance using a lookup table for performance estimation that is stored for each piece of hardware, or estimates the performance using a machine learning model developed based on performance data obtained by executing the artificial intelligence model on actual hardware.

16. The edge device development support method of claim 11, wherein, in the calculating of the cost of the hardware, the processor calculates a cost of the hardware whose performance satisfies the preset performance requirement among the hardware.

17. The edge device development support method of claim 11, wherein, in the calculating of the cost of the hardware, the processor calculates the cost of the hardware by reflecting preset cost conditions for each piece of hardware.

18. The edge device development support method of claim 17, wherein the cost conditions include at least one of price, development difficulty, and hardware development support environment.

19. The edge device development support method of claim 18, wherein the price is normalized based on prices for released hardware products, and the development difficulty and the hardware development support environment are defined by grade and normalized.

20. The edge device development support method of claim 11, wherein, in the selecting of the hardware, the processor selects hardware by reflecting a weight on at least one of the performance and the cost.
